(19) United States
(12) Patent Application Publication
(10) Pub. No.: US 2021/0291584 A1
(43) Pub. Date: Sep. 23, 2021

(54) SCRAPING DEVICE FOR PAINT BRUSH OR ROLLER

(71) Applicant: DAKLAPACK EUROPE B.V., Lelystad (NL)

(72) Inventors: Albert KLAASSEN, LEIDEN (NL); Niels VAN LUNEN, HARDERWIJK (NL)

(73) Assignee: DAKLAPACK EUROPE B.V., Lelystad (NL)

(21) Appl. No.: 17/262,362

(22) PCT Filed: Jul. 23, 2019
(86) PCT No.: PCT/NL2019/050471

§ 371 Date: Jan. 22, 2021

(30) Foreign Application Priority Data
Jul. 24, 2018 (NL) 2021388

(51) Int. Cl. B44D 3/12

(52) U.S. Cl. CPC B44D 3/128

(57) ABSTRACT

The invention provides a scraping device for a paint brush, the scraping device comprising a peripheral wall that extends between an upper end and a lower end, and enclosing a scraping space between said upper end and said lower end. On an inner side turned towards the scraping space, the peripheral wall is provided with a scraping relief that extends along a complete inner perimeter of the peripheral wall. The scraping device is provided with a bottom and/or one or more engaging elements for resting on, preferably for coupling to, an upper edge of a holder, for example a tin. The scraping space is dimensioned for receiving the tip of a brush, and the scraping relief is configured for providing a scraping direction substantially parallel to the upper edge of the peripheral wall.

The present invention relates to a scraping device for a paint brush, comprising a peripheral wall that defines a scraping space.

A scraping device is used in painting activities wherein paint or varnish is applied with a brush or roller, to reduce a surplus of paint or varnish on the brush or roller.

Providing standard paint packaging with an adapter for scraping a brush is known. For example patent publication U.S. Pat. No. 4,964,527 discloses an adapter with scraping edge and a trough for conveying the scraped-off paint back into the packaging.

A drawback of the known adapters for scraping a brush is the limited effectiveness. Generally it is necessary to draw a brush repeatedly along the scraping edge to achieve the desired reduction.

A beaker-shaped paint holder with a slanting, flat scraping wall therein is known from patent publication EP1499506. The scraping wall is provided with a scraping relief over which a roller can be rolled in order to remove an excess of the product. For this purpose, the roller is rolled up and down over the scraping relief until a correct amount of product remains on the roller.

A drawback of the known scraping devices is that the scraping wall positioned slanting therein takes up space at the expense of the useful capacity of the holder. In addition, the up and down movement with a roller for scraping it leads in some cases to unintentional contact with the product, so that rolling is less effective.

One aim of the present invention is to provide a scraping device that offers an alternative to existing adapters and/or paint holders. A further aim of the present invention is to provide a scraping device that overcomes the aforementioned drawbacks at least partially.

In order to achieve this aim, the invention provides a scraping device according to claim 1.

According to the invention, a scraping device for a paint brush according to the invention comprises:

a peripheral wall that extends between an upper end and a lower end, and encloses a scraping space between the upper end and the lower end, and said peripheral wall is provided at the upper end with an upper edge that defines an opening to the scraping space,

wherein the scraping device is provided, near the lower end of the peripheral wall, with a bottom, which closes the scraping space at a lower end thereof, and/or is provided, near the upper end of the peripheral wall, with one or more engaging elements, which are applied on an outer side of the peripheral wall turned away from the scraping space for resting on, preferably for coupling to, an upper edge of a holder, for example a paint tin,

wherein the peripheral wall is provided, on an inner side turned towards the scraping space, with a scraping relief, said scraping relief extending along a complete inner perimeter of the peripheral wall, and between an upper end of the scraping relief located near the upper edge of the peripheral wall and a lower end of the scraping relief located at a distance from the upper edge of the peripheral wall,

wherein the scraping space is dimensioned for receiving the tip of a brush, and the scraping relief is configured for providing a scraping direction substantially parallel to the upper edge of the peripheral wall.

The invention thus provides an alternative to existing adapters and/or paint holders.

A scraping direction according to the invention has a scraping relief that extends along a complete inner perimeter of the peripheral wall, and between an upper end near the upper edge of the peripheral wall and a lower end at a distance from the upper edge of the peripheral wall. The scraping direction is thus provided with an encircling scraping surface.

The scraping surface is configured to provide a scraping direction substantially parallel to the upper edge of the peripheral wall. This means that when a brush is moved in the scraping direction along the scraping surface, the brush passes over irregularities, in the form of projections on and/or depressions in the surface of the inside wall, which have the result that a surplus of paint on the brush is left behind in the scraping relief. The projections on and/or depressions in the surface of the peripheral wall may for example be configured as ribs and/or grooves that extend at least partially at an angle to the scraping direction, or as a pattern of bumps and/or dimples, etc.

It is to be noted that complete ribs and grooves that extend completely parallel to the scraping direction do not function as a scraping relief, since a brush that is moved in the scraping direction along these ribs and grooves does not pass over any irregularities.

Because the scraping relief extends along the complete inner perimeter of the peripheral wall, a brush or roller can thus be scraped off or rolled off in the scraping space and/or the holder in a movement, whether or not continuous, parallel to a surface of the paint, so that unintentional contact with the paint is avoided. The completely encircling relief means that a maximum scraping area is available with an almost completely filled scraping space.

This contrasts with known scraping devices, wherein a flat scraping wall is provided in the holder; scraping walls of this kind only cover a portion of the perimeter of the holder, and are in addition configured for an upward and downward scraping-off or rolling-off direction, and not for an encircling scraping direction.

In addition, compared to the prior art, a scraping direction parallel to the upper edge of the peripheral wall allows for relatively compact dimensioning of the scraping device with respect to a brush or roller. In particular, the invention makes it possible to provide a scraping device suitable for use with a holder in the form of standard paint packaging, typically a paint tin with a diameter that is in the range 5-22 cm, and to provide paint packaging of this kind with a scraping relief that is suitable for use with a roller.

In the prior art, a rolling-off surface, i.e. a scraping surface for a roller, is given a flat configuration, so that two sides of the paint holder have a relatively large width. Generally the width is greater than or equal to the width of a roller. This has the result that the known paint holders provided with a rolling-off surface for rollers are relatively large compared to the roller. Generally paint holders of this kind are of a rectangular shape, with two long sides and two short sides, wherein one of the two long sides is provided with a scraping relief. This makes such scraping devices bulky.

In one embodiment, the scraping device is provided, near the lower end of the peripheral wall, with a bottom that closes the scraping space at a lower end thereof. A scraping device of this kind is suitable for holding paint in the scraping space, at least in the lowest portion thereof, in such a way that at least one portion of the scraping relief projects above the paint, and can thus be used for scraping a brush or roller.

In a further embodiment of a scraping device provided with a bottom, the scraping device is provided, near an upper end of the peripheral wall, with one or more coupling parts for coupling the scraping device to a handle for carrying and/or suspending the scraping device. The scraping device is for example provided with recesses located opposite each other for coupling the scraping device to the ends of a C-shaped handle made of wire, or is for example provided with a receiving hole for coupling the holder to an L-shaped injection-moulded handle. A scraping device of this kind thus also functions as a holder, and can be used independently, i.e. without further holders such as tins and buckets for supporting the scraping direction.

A scraping device of this kind should thus be sturdy enough to be carried and/or suspended by the handle, without further support, and at least partially filled with paint. A scraping device of this kind does not need to be placed in a holder, and can thus be used independently.

In an alternative further embodiment of a scraping device with a bottom, the scraping device is provided with the bottom near the lower end of the peripheral wall and, near the upper end of the peripheral wall, is preferably provided with one or more engaging elements for resting on, preferably for coupling to, an upper edge of a supporting holder, and the scraping device is thus configured to be received in a holder, for example a metal bucket.

By supporting the scraping device with a holder during use, the scraping device can be configured to be relatively flexible, and thus with relatively thin walls. This makes a difference in costs of materials and thus in manufacturing costs. Thus, the scraping device can be replaced without high costs, in particular when there is a change of product or for example paint colour. This makes a difference in cleaning time and cleaning costs.

Because the supporting holder does not come into contact with the paint or varnish, it can easily be reused without cleaning operations. Reuse means that the holder can be made to be relatively robust, without leading to excessively higher costs for the user.

A combination of scraping device in combination with a supporting holder is thus particularly efficient in intensive use, in particular regular product changing.

In one embodiment of a scraping device with a bottom and for fitting in a supporting holder, the one or more engaging elements are configured to rest on an upper edge of a holder, so that the holder supports the scraping device. This is particularly advantageous when the supporting holder is provided with a handle for carrying and/or suspending the holder, and thus for carrying and/or suspending the paint-filled scraping device, supported by the holder. The holder provides the scraping device with additional stability during use.

In one embodiment, the scraping device is provided with a projecting flange, or for example with an encircling trough, configured to rest on the upper edge of a holder. In an alternative embodiment, the scraping device with the bottom rests on a bottom of the holder. In an alternative embodiment the peripheral wall encloses a conical scraping space and the scraping device is dimensioned so that it rests with the outer side of the peripheral wall on a for example ring-shaped opening of a holder. Such a configuration is especially effective in combination with standardized holders provided with a circular opening, for example paint tins. The conical shape of the scraping device, in particular the conical shape of the outer perimeter of the peripheral wall, means that the scraping device can be suitably combined with different types of packaging that vary somewhat in the diameter of the circular opening.

Preferably the one or more engaging elements are configured to couple with an upper edge of the holder for detachably coupling the scraping device to an upper edge of the holder. The engaging means are then for example configured as snap-fitting fingers or as an encircling, downwards-extending flange that is fitted into an encircling slot of the supporting holder when the scraping device is placed in the holder. By coupling the scraping device to the holder, and thus joining the two together, they form as it were a whole and it is possible to provide the scraping device with more, additional stability.

A scraping device provided with a bottom may for example be used in painting activities wherein a quantity of paint or varnish to be processed can be poured into the scraping space in order to be applied therefrom with a brush or roller on a surface to be treated. The scraping device can be filled, optionally repeatedly, from the original paint packaging and thus offers the possibility of working with smaller volumes of paint. This means that the user has to lift less weight, it is more flexible and the work can be carried out more accurately.

In an alternative embodiment of a scraping device according to the invention, the scraping device is provided with a peripheral wall with a free lower end, and the scraping device is thus not provided with a bottom, the peripheral wall near the upper end thereof is preferably provided with the one or more engaging elements, and the scraping device is thus configured to be received in a paint-filled holder, for example a paint tin made of metal, for example standard paint packaging. By providing the scraping device with an open lower end, paint can enter from the bottom of the scraping space, and the scraping device can thus be put in a paint tin from the top.

In one embodiment, the scraping device is provided with a projecting flange, or for example with an encircling trough, configured to rest on the upper edge of a holder. In an alternative embodiment the peripheral wall encloses a conical scraping space and the scraping device is dimensioned so that it rests with the outer side of the peripheral wall on a for example ring-shaped opening of a holder.

A scraping device without a bottom can be used in painting activities wherein the paint or varnish to be processed is held in standard packaging. The scraping device is then placed in the opening of the packaging, wherein the scraping space is located at least partly above the level of the paint or varnish in the packaging. The scraping device thus adds functionality to standard packaging, and in particular makes it possible to scrape off a brush or roller efficiently.

The invention thus provides three different embodiments of the scraping device, namely: an embodiment wherein the scraping device is provided with a handle, an embodiment wherein the scraping device is to be placed in a holder to offer stability during use, and an embodiment wherein the scraping device is to be placed in a paint-filled holder. In the first two embodiments the scraping device is provided with a bottom, so that the scraping space can be partially filled with paint. In such an embodiment the scraping device thus does not need to be provided with further engaging elements.

A scraping device according to the invention has a scraping relief that extends along a complete inner perimeter of the peripheral wall, and between an upper end near the upper edge of the peripheral wall and a lower end at a distance from the upper edge of the peripheral wall. Thus, the scraping device is provided with an encircling scraping surface that makes it possible to scrape off a brush or roller efficiently.

In one embodiment according to the invention, the peripheral wall extends about a central axis, and in a plane perpendicular to the central axis the peripheral wall has a circular cross-section, wherein the radius between peripheral wall and central axis has a length in the range from 2.5 cm to 15 cm, preferably in the range from 5 cm to 12 cm.

In a preferred embodiment the peripheral wall extends about a central axis, and in a plane perpendicular to the central axis the peripheral wall has a circular cross-section. The curved peripheral wall thus provides a continuous rolling-off surface, i.e. a rolling-off surface with a constant curvature in the scraping direction, which further facilitates scraping-off, and especially rolling-off. Such an embodiment is especially advantageous for scraping-off, more particularly rolling-off, of rollers.

In one embodiment according to the invention, the upper edge of the peripheral wall is configured as a scraping edge for scraping a brush, so that the brush can be drawn along the scraping relief and over the scraping edge.

In a further embodiment according to the invention, the upper edge of the peripheral wall is configured as a scraping edge, and the peripheral wall is provided at the upper edge, on an outer side turned away from the scraping space, with a projecting trough wall that delimits a trough running along the outer side of the peripheral wall, said trough preferably extending along a complete outer perimeter of the peripheral wall.

In such an embodiment, the scraping device, with scraping edge and trough, is also suitable for scraping a brush over the upper edge of the peripheral wall, in addition to scraping along the scraping relief on the inside of the peripheral wall. Scraped-off paint that runs along the outer side of the peripheral wall is caught in the trough. This prevents the rest of the outer side of the peripheral wall, and/or an optional holder in which the scraping device is placed, being soiled by the paint.

Thus, a portion of the brush can be scraped off along the scraping relief, preferably with a twisting motion from the wrist, and an additional portion of the brush can be scraped-off over the scraping edge, preferably with a pulling motion perpendicular to the scraping wall. This makes it possible to scrape-off a large portion of the brush efficiently, wherein the brush only has to be drawn along the scraping edge once.

With a standard paint tin it is possible to scrape a brush over an edge of the paint tin. However, to scrape a large portion of the brush this generally has to be pulled over the edge two or more times, wherein the brush must be tilted or turned between the two passes. Moreover, when the tin is still completely full, the edge is close to the paint, which makes scraping more difficult.

In one embodiment of a scraping device according to the invention, the trough is connected to the scraping space via at least one passage in the peripheral wall, this passage being formed by a U-shaped depression in the upper edge, said depression extending from the upper edge of the peripheral wall to the bottom of the trough. Thus, the paint caught in the trough can flow back again into the scraping space. This kind of configuration of the trough, and especially of the passage, makes it possible to produce the scraping device efficiently, and makes it possible in particular to injection-mould the scraping device using a simple mould.

In one embodiment, the scraping device is provided with a trough along the outer side of the peripheral wall, and the scraping relief extends on the inside of the peripheral wall to above the bottom of the trough. In such an embodiment, the peripheral wall, at the upper edge thereof, is provided with a trough on one side and with a scraping relief on the opposite side at the same height. Thus, the inside of the peripheral wall is used optimally for providing a scraping relief.

In one embodiment according to the invention the scraping relief extends on the inside of the peripheral wall to some distance from the upper edge, preferably to a distance in the range 2-5 mm, for example a distance of 3 mm, from the upper edge. In one such embodiment the upper edge is free from scraping relief on the inside, and is thereby optimally usable as a scraping edge.

In one embodiment according to the invention the trough wall ends under the upper edge of the peripheral wall, in other words: the peripheral wall projects above the trough wall. Such a configuration reduces the likelihood, during scraping along the scraping edge, of a brush coming into contact with the trough wall, in particular with an upper edge of the trough wall. Contact with the upper edge of the trough wall is undesirable because this could result in paint from the brush getting onto an outer edge of the trough wall. This paint is then not caught in the trough, is lost and/or may lead to spots on the outside of the scraping device or elsewhere.

In one embodiment according to the invention the trough wall is formed in such a way that the trough has a slope towards the at least one passage. A trough of this kind efficiently leads trapped paint, via the at least one passage, back to the scraping space.

In one embodiment according to the invention the scraping relief extends over an upper part of the peripheral wall, for example over two thirds, a half, a third or a quarter of the peripheral wall.

In one embodiment according to the invention the inside of the peripheral wall has a substantially smooth surface between the scraping relief and the bottom. Paint removed from the brush by the scraping relief runs along the scraping relief towards the bottom and, if the scraping device is filled to under the scraping relief, over the smooth portion of the peripheral wall. The smooth peripheral wall along the bottom makes it easy to remove paint residues with a brush.

In one embodiment according to the invention the scraping relief comprises several parallel ribs, said ribs extending between an upper end near the upper edge and a lower end at a distance from the upper edge. A ribbed structure seems especially effective in guiding the user towards the correct scraping direction, i.e. substantially transverse to the ribs. For example, a scraping structure comprising a pattern of bumps does not give the user any indication as to the best direction for scraping the brush. In addition, it was found that a ribbed structure combines an effective scraping direction with an efficient draining direction in the lengthwise direction of the ribs, on condition that the ribs extend in a substantially vertical direction.

In one embodiment the ribs are substantially equidistant and in particular parallel. The ribs are preferably rectilinear.

In one embodiment the peripheral wall extends about a central axis, and the ribs extend in a direction substantially parallel to the central axis.

In an alternative embodiment the ribs extend at an acute angle to the bottom and the upper edge. The ribs then describe a helical shape, i.e. a spiral shape relative to the central axis.

In one embodiment, the scraping device is provided with a bottom and the lower end of the ribs is located at a distance from the bottom, so that the ribs extend over only an upper part of the inside wall, for example over two-thirds, a half, a third or a quarter of the inside wall. This is efficient because in principle only the portion at a distance from the bottom is used for scraping a brush, since the portion near the bottom is mainly below the paint level during use. In addition, a smooth wall is easier to produce during the production process, in particular when the scraping device is manufactured by injection moulding.

When the scraping device is not provided with a bottom, and is intended to be fitted in a paint tin, the scraping device is preferably configured so that the peripheral wall does not reach the bottom of the paint tin. This is to enable the user to reach the corners of the bottom of the paint tin with a brush. In such an embodiment the scraping relief preferably extends to the lower end of the peripheral wall.

In one embodiment, the scraping device is manufactured by injection moulding. In one embodiment the scraping device is formed complete as a single whole from a suitable plastic and comprises in particular a plastic injection moulding.

In one embodiment, at least the peripheral wall is manufactured by the injection moulding technique, and the scraping relief is provided along an upper part of the inside of the peripheral wall, and the lower part of the peripheral wall is smooth. In such an embodiment the ribs are preferably formed by leaving grooves between the ribs, so that the top of the ribs is flush with, or lower than, the smooth surface adjacent to the lower end of the peripheral wall. This embodiment is particularly efficient when the scraping device is provided with a bottom, since it is to be produced removably, and so is to be manufactured with an injection-moulding mould provided with a single core for forming the inside of the peripheral wall.

In one embodiment the peripheral wall encloses an interior space of conical shape. In a further embodiment the peripheral wall is provided along the upper edge with a scraping relief comprising parallel ribs, said ribs having a height in a direction perpendicular to the peripheral wall, said height gradually decreasing towards the lower end of the ribs, i.e. towards the lower end of the peripheral wall.

In one embodiment the ribs have a width along the inside of the peripheral wall and a height perpendicular to the inside of the peripheral wall. In one embodiment the width of the ribs is in the range from 0.5 to 1 mm, and a rib has for example a width of 0.75 mm, and the height of the ribs is in the range from 0.2 to 0.8 mm, and a rib has for example a height of 0.5 mm.

In one embodiment the ribs have, in a direction perpendicular to the inside of the peripheral wall, a width in the range from one to three times the height of the rib, for example the ribs have a width substantially equal to one and a half times the height of the rib.

In one embodiment the ribs are at a mutual distance of less than six times the width of a rib, for example at a mutual distance of about four times the width of a rib.

In one embodiment according to the invention the outer perimeter of the peripheral wall gets narrower towards the lower end of the peripheral wall, so that the peripheral wall encloses a conical scraping space, and so that the scraping device can fit in a scraping space of a similar further scraping device. Thus, similar holders can be nested together. As a result, a holder will take up less space during storage and transport.

With a view to removing a scraping device from a scraping space of a similar scraping device, a further particular embodiment is characterized in that on the outer side of the peripheral wall a set of vertical draft ribs is formed, by which the peripheral wall rests on an inside wall of the further holder. These ribs impose a mutual gap between an inside wall of one holder and an inside wall of a further holder nested therein.

In a further embodiment the peripheral wall is provided on the outer side with one or more vertical draft ribs by which the peripheral wall rests on an inside wall of the peripheral wall of a further scraping device.

The invention further provides an assembly comprising a scraping device according to the invention, said scraping device being provided with a bottom near the lower end of the peripheral wall, and a holder, for example a holder made of metal for providing additional stability during use, said holder preferably being provided with a handle, for example a C-shaped handle made of wire.

The invention further provides an assembly comprising a scraping device provided with a projecting trough wall that delimits a trough running along the outer side of the peripheral wall, and a cover for closing the feed opening of the scraping device, said cover being configured to engage on an upper edge of the trough wall in such a way that the cover remains free from contact with the upper edge of the peripheral wall. Thus, the cover does not come into contact with the scraping edge of the scraping device, or any paint residues left behind on said scraping edge.

The invention further provides a method for using a scraping device provided with a bottom and, near the upper end of the peripheral wall, one or more coupling parts for coupling the scraping device to a handle for carrying and/or suspending the scraping device, said method comprising the steps:
filling the scraping device with paint so that an upper portion of the scraping relief projects above a paint surface, when the scraping device is mounted on a horizontal supporting surface,
dipping a brush in the paint, and then scraping the brush along the scraping relief and optionally the scraping edge of the scraping device.

The invention further provides a method for using a scraping device provided with a bottom, said method comprising the steps:
placing the scraping device in a holder, preferably comprising coupling the scraping device to an upper edge of the holder,
filling the scraping device with paint so that an upper portion of the scraping relief projects above a paint surface, when the holder is mounted on a horizontal supporting surface,
dipping a brush in the paint, and then scraping the brush along the scraping relief and optionally the scraping edge of the scraping device.

The invention further provides a method for using a scraping device without a bottom, said method comprising the steps:
placing the scraping device in an at least partially paint-filled holder, preferably comprising coupling the scraping device to an upper edge of the holder, so that an upper portion of the scraping relief projects above a paint surface, when the holder is mounted on a horizontal supporting surface,
dipping a brush in the paint, and then scraping the brush along the scraping relief and optionally the scraping edge of the scraping device.

The invention will be explained in more detail hereunder on the basis of embodiment examples and an associated drawing, in which:

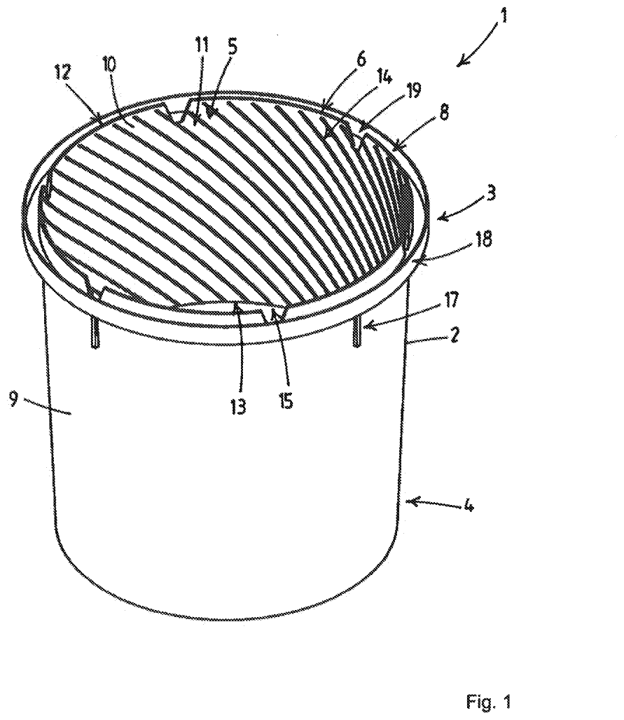

FIG. 1 shows a perspective view of a first embodiment example of a scraping device according to the invention;

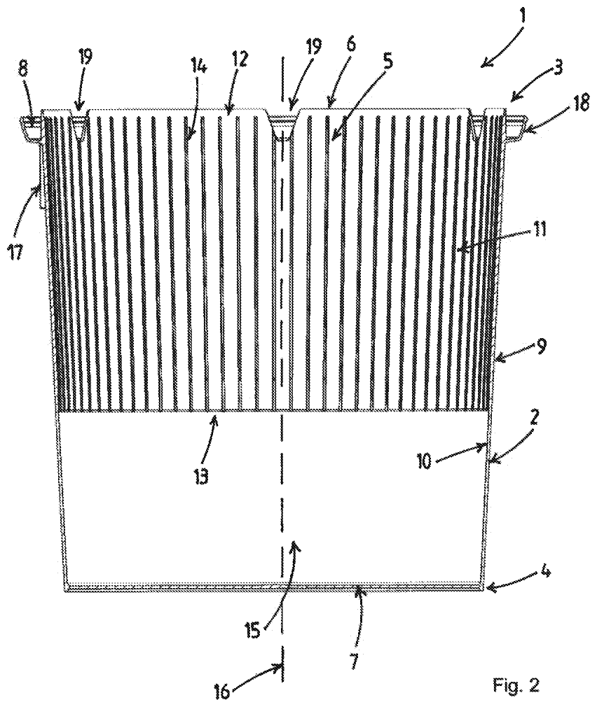

FIG. 2 shows a cross-sectional side view of a second embodiment example of a scraping device according to the invention;

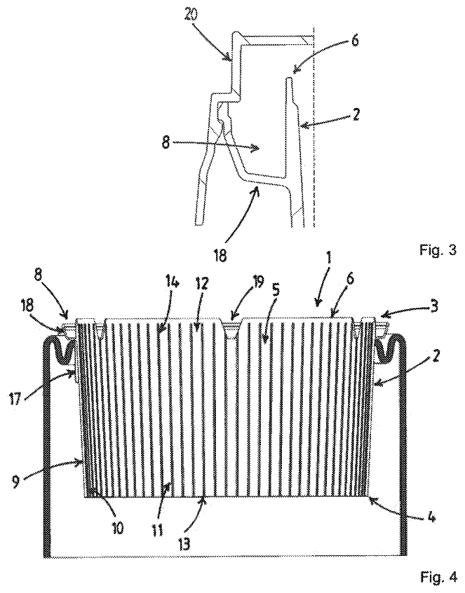

FIG. 3 shows a cross-sectional side view of a portion of a cover and of an upper edge of the scraping device in FIG. 2; and

FIG. 4 shows a cross-sectional side view of a second embodiment example of a scraping device according to the invention.

It should be noted that the figures are purely schematic and are not always drawn to (an identical) scale. In particular, for clarity some dimensions are exaggerated to a varying extent. Equivalent parts are indicated with one and the same reference number in the figures.

FIG. 1 shows a scraping device 1 for a paint brush. The scraping device 1 comprises a peripheral wall 2 that extends between an upper end 3 and a lower end 4. The peripheral wall encloses a scraping space 5 between the upper end and the lower end, and is provided at the upper end with an upper edge 6 that defines an opening 7 to the scraping space 5.

Near the lower end of the peripheral wall 2, the scraping device 1 is provided with a bottom 7 which closes the scraping space 5 at a lower end thereof. Near the upper end of the peripheral wall 2, the scraping device 1 is provided with an engaging element in the form of a trough 8, which is applied on an outer side 9 of the peripheral wall 2 turned away from the scraping space, for resting on an upper edge of a holder, for example a paint tin.

On an inner side 10 turned towards the scraping space, the scraping device 1 is provided with a scraping relief 11. The scraping relief 11 extends along a complete inner perimeter of the peripheral wall 2, and between an upper end 12 of the scraping relief 11 located near the upper edge 6 of the peripheral wall 2, and a lower end 13 of the scraping relief 11 located at a distance from the upper edge 6 of the peripheral wall 2.

The scraping device 1 shown in FIG. 1 may for example be used in painting activities wherein an amount of paint or varnish is received in the scraping space therein such that at least a portion of the scraping relief projects above the surface of the liquid.

The scraping space 1 is dimensioned for receiving the tip of a brush, and the scraping relief 11 is configured to provide a scraping direction substantially parallel to the upper edge of the peripheral wall.

Via the opening 7, a brush can be dipped into the paint in the scraping space, and can then be scraped off with a twisting motion along the scraping relief, and, if necessary, can then be scraped over the scraping edge formed by the upper edge 6 of the peripheral wall 2.

The holder typically has a capacity of between 0.5 and 1 litre and has a height of the order of between 10 and 20 centimetres. This example is based on a holder formed completely from a suitable plastic, such as polyethylene or polypropylene, manufactured by an injection moulding process. The holder is thus formed as a single whole. Within the scope of the invention, some other suitable plastic may be used, preferably a plastic with a hydrophobic surface.

It should be noted that in the embodiment example shown, the peripheral wall 2 provides, in combination with an encircling scraping relief 11 that is effective in a direction parallel to the upper edge 6 of the scraping device, a curved scraping surface that is suitable for scraping-off or rolling-off a roller.

In the example shown, the peripheral wall 2 extends about a central axis 16, and the peripheral wall 2 has a circular cross-section in a plane perpendicular to the central axis 16. Moreover, the outer perimeter of the peripheral wall 2 gets narrower towards the lower end 4 of the peripheral wall, and the scraping device 1 can fit in a scraping space of a similar further scraping device. Thus, similar holders can be nested together. As a result, a holder will take up less space during storage and transport.

The scraping device shown in FIG. 1 is provided with a scraping relief 11 with a number of successive ribs 14. The ribs 14 are equidistant and parallel to each other with a mutual spacing of the order of 10 to 25 millimetres, here approx. 15 millimetres.

In the example shown, the ribs 14 extend over only a part of the height of the peripheral wall 2, wherein the wall has a smooth surface 15 between the bottom 7 and the scraping relief.

The ribs 14 of the embodiment of a scraping device according to the invention shown in FIG. 1 extend at an acute angle to the bottom 7 and the upper edge 6 of the peripheral wall 2. The ribs 21 describe a helical shape, i.e. a spiral shape relative to the central axis 16.

In the preferred embodiment shown in FIG. 2, the ribs 14 extend in a direction substantially parallel to the central axis 16.

A ribbed structure seems to be especially effective in guiding the user towards the correct scraping direction, preferably substantially transverse to the ribs. By providing the scraping relief with vertically oriented ribs, it is made clear to the user that a brush can be scraped in a direction parallel to the scraping edge 6, in particular parallel to the surface of the liquid paint in the scraping space.

It was found that a ribbed structure combines an effective scraping direction with an efficient draining direction in the lengthwise direction of the ribs, provided that the ribs extend in a substantially vertical direction.

In the embodiment example shown, the upper edge 6 of the peripheral wall 2 is configured as a scraping edge. For this purpose, the peripheral wall 2 is provided, on the upper edge, on an outer side 9 turned away from the scraping space 5, with a projecting trough wall 18. The trough wall 18 delimits the trough 8, which runs along the outer side of the peripheral wall 2, and in the example shown extends along a complete outer perimeter of the peripheral wall 2. When a brush is scraped over the upper edge of the peripheral wall, paint may end up on the outer side of the peripheral wall. By providing a trough, this paint is caught, and the paint is prevented from running further over the outer side of the peripheral wall, and/or over the holder in which the scraping device is fitted.

In the embodiment example shown, the trough 8 is connected to the scraping space 5 via several passages 19 in the peripheral wall 2. Each passage 19 is formed by a U-shaped depression in the upper edge 6, said depression extending from the upper edge of the peripheral wall 2 to the bottom of the trough 8.

In the embodiment example shown, the peripheral wall 2 extends above the trough 8, and above an upper end of the trough wall 18, so that during scraping over the upper edge 3 of the peripheral wall 2, a brush does not have to come into contact with the upper end of the trough wall 18. Thus, no paint ends up on the outside of the trough 8.

Because the scraping relief 11 extends on the inside 10 of the peripheral wall 2 to above the bottom of the trough 8, there is optimum usage of the internal surface, i.e. up to the scraping edge, for scraping a brush. In addition, a user will not fill the scraping space to above the passages of the trough. This means that a portion of the scraping relief is always accessible for scraping a brush.

The trough 8 and the trough wall 18 extend in this example over a full perimeter of the peripheral wall 2.

A scraping device according to the invention may for example be used in a holder, to provide an easily manageable amount of paint without needing to break open a full paint package.

By combining a scraping device that is provided with a bottom, and a holder, the scraping device can be made relatively light and flexible. Thus, the scraping device can be replaced without high costs when there is a change of product or for example paint colour. Because the holder does not come into contact with the paint or varnish, it can be reused easily without major cleaning operations. Since the holder is reusable, it can be relatively robust, without leading to excessively higher costs for the user.

In addition, the paint or varnish can be bought in large packs, and can be applied from a relatively compact combination of holder and scraping device.

FIG. 3 shows a cross-sectional side view of a portion of a cover 20 and an upper edge 6 of the scraping device 1 in FIG. 2. By providing a cover, the contents of the scraping device, or of the holder in which the scraping device is placed, can be protected. In the preferred embodiment shown, the cover 20 is configured for fitting on the trough wall 18 instead of the, higher, scraping edge 6. This prevents the cover 20 coming into contact with paint left behind on the scraping edge 6. In addition, this configuration provides protection of the trough, so that the paint or varnish still present therein does not dry out directly, but can still flow back into the scraping space.

With a view to compact storage and transport, the holder can be nested in a similar holder, as illustrated in FIG. 2. For this purpose, the peripheral wall 12 gets narrower towards the bottom 10, so that it will fit in the product chamber 14 of an underlying holder. To promote mutual release of the holders, a set of draft ribs 17 is formed on an outer side of the wall, which ensure mutual separation of the holders.

The invention further provides an assembly, said assembly comprising a scraping device provided with a projecting trough wall that delimits a trough running along the outer side of the peripheral wall, and preferably a cover for closing the feed opening of the scraping device, said cover being configured to engage on an upper edge of the trough wall in such a way that the cover remains free from contact with the upper edge of the peripheral wall.

The embodiments shown in FIG. 1 and FIG. 2 are provided with a bottom, and are configured to rest, with an encircling trough, on an upper edge of a holder. The scraping devices shown are thus configured to be fitted into a holder, for example a bucket made of metal, and to be filled with paint or varnish.

In an alternative embodiment, the scraping device is provided, near an upper end of the peripheral wall, with one or more coupling parts for coupling the scraping device to a handle for carrying and/or suspending the scraping device. The scraping device is for example provided with recesses located opposite each other for coupling the scraping device to the ends of a C-shaped handle made of wire, or for example is provided with a receiving hole for coupling the holder to an L-shaped injection-moulded handle.

FIG. 4 shows an alternative embodiment of a scraping device 1 according to the invention. The scraping device is placed in a paint tin 21, the upper end of which is shown in cross-section in the figure. The scraping device 1 is provided with a peripheral wall with a free lower end, and thus is not provided with a bottom. Just like the embodiment examples shown in FIG. 1 and FIG. 2, the scraping device is further provided with a projecting flange in the form of a trough wall. The trough wall delimits a trough running along the outer side of the peripheral wall, and which, in the example shown, extends along a complete outer perimeter of the peripheral wall. The encircling trough, in particular the trough wall, is provided for being supported on the upper edge of a holder. Because the trough wall rests on the edge of the paint tin, and the inside wall extends to above the trough, a part of the scraping relief will in practice always project above the paint surface, even if the paint tin is almost full. Thus, even with an almost full paint tin, a brush can be scraped along the scraping relief.

The invention provides a particularly practical scraping device for paint, varnish or a similar product, wherein various applicators such as paint rollers and brushes can be scraped off particularly effectively and easily. It should be made clear that the invention is by no means limited to the embodiment examples shown. On the contrary, for an average person skilled in the art, many other variations and manifestations are possible within the scope of the invention.

Thus, the embodiment examples shown are based on a completely round, i.e. cylindrical, holder, but it should be obvious that the invention is also applicable in a holder with some other perimeter, for example rectangular to a varying extent.

### REFERENCE NUMBERS

01 scraping device
02 peripheral wall
03 peripheral wall upper end
04 peripheral wall lower end
05 scraping space
06 peripheral wall upper edge
07 bottom
08 trough
09 peripheral wall outer side
10 peripheral wall inner side
11 scraping relief
12 scraping relief upper end
13 scraping relief lower end
14 ribs of the scraping relief
15 smooth surface
16 central axis
17 draft ribs
18 trough wall
19 passage
20 cover
21 paint tin

1-27. (canceled)

28. A scraping device for a paint brush, the scraping device comprising a peripheral wall that extends between an upper end and a lower end, and enclosing a scraping space between the upper end and the lower end, and
wherein said peripheral wall is provided at the upper end with an upper edge that defines an opening to the scraping space,
wherein the scraping device is provided, near the lower end of the peripheral wall, with a bottom, which closes the scraping space at a lower end thereof,
wherein the peripheral wall is provided, on an inner side turned towards the scraping space, with a scraping relief, said scraping relief extending along a complete inner perimeter of the peripheral wall, and between an upper end of the scraping relief located near the upper edge of the peripheral wall and a lower end of the scraping relief located at a distance from the upper edge of the peripheral wall, and
wherein the scraping space is dimensioned for receiving the tip of a brush, and the scraping relief is configured for providing a scraping direction substantially parallel to the upper edge of the peripheral wall.

29. The scraping device according to claim 28, wherein the scraping device near the upper end of the peripheral wall is provided with one or more coupling parts for coupling the scraping device to a handle for carrying and/or suspending the scraping device.

30. The scraping device according to claim 28, wherein the scraping device near the upper end of the peripheral wall is provided with one or more engaging elements, the one or more engagement elements being applied on an outer side of the peripheral wall turned away from the scraping space for resting on, or for coupling to, an upper edge of a holder, and
wherein the scraping device is thus configured to be fitted into the holder.

31. The scraping device according to claim 28, wherein the upper edge of the peripheral wall is configured as a scraping edge, and the peripheral wall is provided, at the upper edge, on an outer side turned away from the scraping space, with a projecting trough wall that delimits a trough running along the outer side of the peripheral wall, and wherein the trough is connected to the scraping space via at least one passage in the peripheral wall.

32. The scraping device according to claim 31, wherein the trough wall ends under the upper edge of the peripheral wall.

33. The scraping device according to claim 31, wherein the scraping relief extends on the inside of the peripheral wall to above the bottom of the trough, and to above the trough wall.

34. The scraping device according to claim 28, wherein the scraping relief extends on the inside of the peripheral wall to a distance from the upper edge in the range 2-3 mm.

35. The scraping device according to claim 28, wherein the lower end of the scraping relief is located at a distance from the lower end of the peripheral wall, so that the scraping relief extends over only an upper part of the inside wall.

36. The scraping device according to claim 35, wherein the inside of the peripheral wall has a substantially smooth surface between the scraping relief and the bottom.

37. The scraping device according to claim 28, wherein the scraping relief comprises several parallel ribs between an upper end near the upper edge and a lower end at a distance from the upper edge.

38. The scraping device according to claim 37, wherein the peripheral wall extends about a central axis, and the ribs extend in a direction substantially parallel to the central axis.

39. The scraping device according to claim 37, wherein the ribs extend at an acute angle to the upper edge.

40. The scraping device according to claim 37, wherein the ribs have a width along the inside of the peripheral wall and have a height perpendicular to the inside of the peripheral wall, and wherein the ribs have a width in the range from one to three times the height of the rib.

41. An assembly comprising:
the scraping device according to claim 30; and
a holder for providing additional stability during use, said holder being provided with a handle.

42. Assembly comprising:
the scraping device according to claim 31; and
a cover for closing the feed opening of the scraping device, said cover being configured to close and fit onto an upper edge of the trough wall in such a way that the cover remains free from contact with the upper edge of the peripheral wall.

43. A scraping device for a paint brush, the scraping device comprising a peripheral wall that extends between an upper end and a lower end, and enclosing a scraping space between the upper end and the lower end,
wherein the lower end of the peripheral wall is a free lower end,
wherein said peripheral wall is provided at the upper end with an upper edge that defines an opening to the scraping space,
wherein the scraping device is provided, near the upper end of the peripheral wall, with one or more engaging elements, the one or more engaging elements being applied on an outer side of the peripheral wall turned away from the scraping space for resting on, or for coupling to, an upper edge of a holder,
wherein the peripheral wall is provided, on an inner side turned towards the scraping space, with a scraping relief, said scraping relief extending along a complete inner perimeter of the peripheral wall, and between an upper end of the scraping relief located near the upper edge of the peripheral wall and a lower end of the scraping relief located at a distance from the upper edge of the peripheral wall, and
wherein the scraping space is dimensioned for receiving the tip of a brush, and the scraping relief is configured for providing a scraping direction substantially parallel to the upper edge of the peripheral wall.

44. The scraping device according to claim 43, wherein the upper edge of the peripheral wall is configured as a scraping edge, and the peripheral wall is provided, at the upper edge, on an outer side turned away from the scraping space, with a projecting trough wall that delimits a trough running along the outer side of the peripheral wall.

45. A method for using the scraping device according to claim 29, said method comprising the steps:
filling the scraping device with paint so that an upper portion of the scraping relief projects above a paint surface, when the scraping device is mounted on a horizontal supporting surface;
dipping a brush in the paint; and
then scraping the brush along the scraping relief.

46. A method for using the scraping device according to claim 30, said method comprising the steps:
placing the scraping device in a holder, comprising coupling the scraping device to an upper edge of the holder;
filling the scraping device with paint so that an upper portion of the scraping relief projects above a paint surface, when the holder is mounted on a horizontal supporting surface;
dipping a brush in the paint; and
then scraping the brush along the scraping relief.

47. A method for using the scraping device according to claim 43, said method comprising the steps:
placing the scraping device in an at least partially paint-filled holder, comprising coupling the scraping device to an upper edge of the holder, so that an upper portion of the scraping relief projects above a paint surface, when the holder is mounted on a horizontal supporting surface;
dipping a brush in the paint; and
then scraping the brush along the scraping relief.
